(19) United States
(12) Patent Application Publication
(10) Pub. No.: US 2016/0156989 A1
(43) Pub. Date: Jun. 2, 2016

(54) BIRD PHOTO BOOTH

(71) Applicant: Bryson C. Lovett, Los Angeles, CA (US)

(72) Inventor: Bryson C. Lovett, Los Angeles, CA (US)

(21) Appl. No.: 14/073,240

(22) Filed: Nov. 6, 2013

Related U.S. Application Data
(60) Provisional application No. 61/723,518, filed on Nov. 7, 2012.

(51) Int. Cl. H04N 21/61; H04N 5/225; A01K 39/01; H04N 7/18; A01K 29/00; H04N 5/77; H04N 21/4223

(52) U.S. Cl. CPC H04N 21/6106; H04N 5/772; H04N 5/2253; H04N 5/2254; H04N 5/2252; H04N 21/4223; H04N 7/183; A01K 29/005; A01K 39/01

(57) ABSTRACT

A video capture apparatus includes a box, an insert configured to fit inside the box and to receive an electronic device having a camera. A front cover of the box is configured such that the insert positions the camera to view through a hole in the front cover. A lens mount is configured to receive a lens over the hole. A feeder is capable of being positioned such that the camera is pointed through the lens to an animal using the feeder.

### RELATED APPLICATION INFORMATION

This Application is a non-provisional Application of Provisional Application Ser. No. 61/723,518, entitled “Photo Booth for Birds”, filed Nov. 7, 2012, and claims priority from this Application and incorporates this Application by reference.

### FIELD OF THE INVENTION

The present invention generally relates to bird photography and the like. More specifically, the invention relates to a bird photo booth incorporating a mobile electronic device that provides close range photography of birds.

### BACKGROUND OF THE INVENTION

Bird watching is one of the most popular and fastest growing recreational activities in the nation, involving over 65.4 million Americans who feed wild birds around their homes. In fact, bird-watching or birding has become so popular that there stores, magazines and travel agents that are devoted to it.

More than $36 billion is spent on bird-watching and feeding in the country each year, according to the U.S. Fish and Wildlife Service.

Backyard birding or watching birds around the home is the most common form of bird-watching in the US. Eighty-eight percent (55 million) of birders are backyard birders.

The average birder is 50 years old and is more likely to be female. Over 56% of birders have an annual income exceeding $50,000.

As far as close up bird imaging, currently used technology involves very expensive digital single lens reflex (DSLR) cameras and telephoto lenses. One existing birdcam is The Wingscapes birdcam, which is a motion detection camera that is set up to point at bird feeders. This device integrates low-resolution cameras whose shutter is activated by motion. However, the Wingscapes system cannot let the user visualize birds remotely. Further, the Wingscapes system cannot let the user directly control image capture remotely in real time. There is no interaction between the user and the birds.

Therefore, there is still a need for a system and method that overcomes the shortcomings of the above-mentioned prior art. The system and method described herein augments the bird watching experience by allowing for real time interaction and unprecedented capture of exquisite detail.

### SUMMARY OF THE INVENTION

According to a preferred embodiment, video capture apparatus, comprises: a box; an insert configured to fit inside the box and to receive an electronic device having a camera; a front cover of the box configured such that the insert positions the camera to view through a hole in the front cover; a lens mount configured to receive a lens over the hole; and a feeder capable of being positioned such that the camera is pointed through the lens to an animal using the feeder.

According to another preferred embodiment, a video capture apparatus, comprises: a box; an insert configured to fit inside the box and to receive a first electronic device having a camera; a front cover of the box configured such that the insert positions the camera to view through a hole in the front cover; a lens mount configured to receive a lens over the hole; a feeder capable of being positioned such that the camera is pointed through the lens to an animal using the feeder; and a network connection configured to provide video signals captured by the camera of the first electronic device to a location on a network that is accessible for viewing by a second electronic device.

According to yet another preferred embodiment, a video capture method, comprises: fitting an insert inside a box to receive a first electronic device having a camera; closing a front cover of the box such that the insert positions the camera to view through a hole in the front cover; receiving a lens over the hole; positioning a feeder such that the camera is pointed through the lens to an animal using the feeder; and providing signals captured by the camera to a location that is accessible on a network by a second electronic device capable of displaying the signals captured by the camera.

### BRIEF DESCRIPTION OF THE DRAWINGS

FIG. 1 is a left front perspective view of a bird photo booth according to one embodiment;

FIG. 2 is a back left rear perspective view of the bird photo booth according to the embodiment of FIG. 1;

FIG. 3 is a diagram representing an exemplary second electronic device that is capable of accessing the internet to view captured video and images from the embodiment of FIG. 1;

FIG. 4 is a left front perspective view of the bird photo booth according to the embodiment of FIG. 1 shown with the door in the open position;

FIG. 5 is a bottom left perspective view of further detail of the box of the bird photo booth of the embodiment of FIG. 1;

FIG. 6 is a diagram that illustrates an alternative fitting of the bird photo boot of the embodiment of FIG. 1 on a camera stand;

FIG. 7 is a diagram illustrating an insert having a differently shaped cutout for the first electronic device than that shown in FIG. 4 according to the embodiment of FIG. 1;

FIG. 8 is a diagram illustrating an alternative bird photo booth connected to the rod of the embodiment of FIG. 1;

FIG. 9 is a bird photo booth with a solar panel attached according to one embodiment; and

FIG. 10 is left rear perspective view of another embodiment of the bird photo booth with a rear clear window that can be opened and closed.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

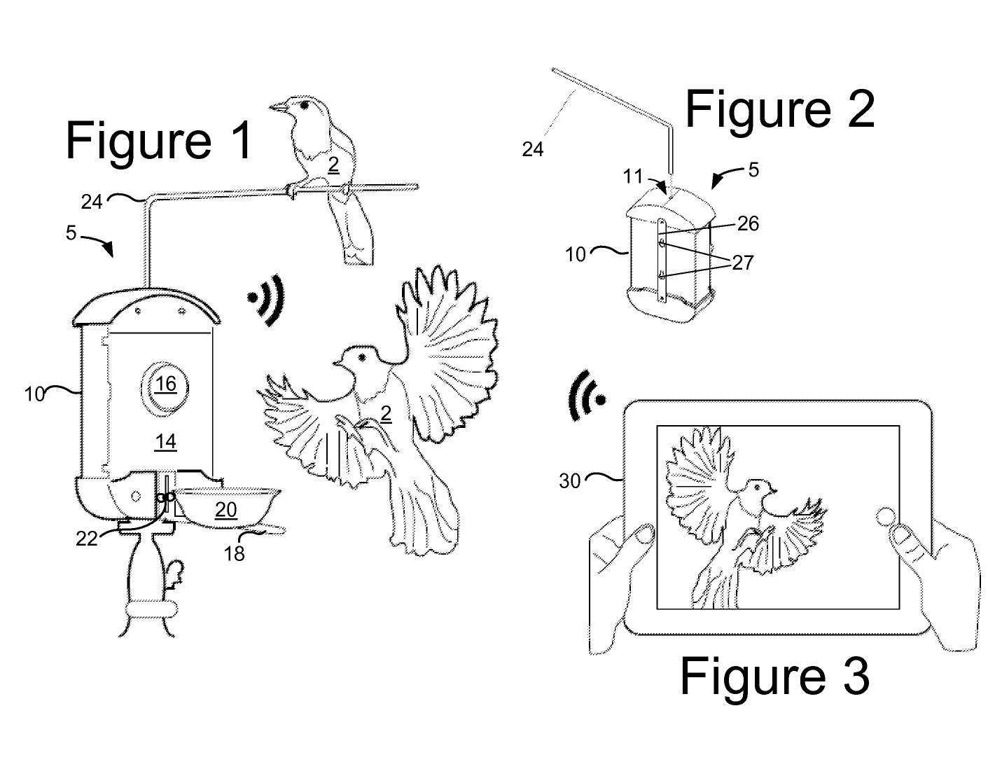

Broadly, embodiments of the present invention generally provide a bird photo booth incorporating a mobile device having a camera or the like. With reference to FIG. 1, a left front perspective view of a bird photo booth 5 according to one embodiment is shown. A wood or plastic box enclosure 10 may comprise a sliding or hinged door 14 that may have a hole with a lens mount that may be threaded to accept screw on macro lenses 16 and/or filters. The interchangeable macro lens 16 that may be screwed onto door 14 may, in one embodiment, comprise a DSLR lens.

An adjustable and detachable metal platform 18 may allow for a bird food dish 20 to be positioned anywhere along its length. The bird food dish 20 may, in one embodiment slide onto the detachable platform 18. A metal thumb screw 22 may secure the detachable platform 18 to the box 10. A metal rod 24 may screw into the top of the box enclosure 10 that may allow for different bird specific feeders to be attached on the rod 24, or for allowing a bird 2 to stand thereon.

With reference to FIG. 2, a back left rear perspective view of the bird photo booth 5 according to the embodiment of FIG. 1 is shown. A metal keyhole mounting bracket 26 may be attached raised from the back of the wood or plastic enclosure 10. The keyhole bracket 26 has one or more keyhole slots 28 allowing the bird photo booth 5 to be mounted over any exposed screw or nail head on a vertical flat surface, such as a wall or the like.

In one embodiment, the rod 24 may be detachable and fit or screwed into a threaded hole-mount 11 at the top of the box 10, or in other embodiments, on the side of the box 10.

The bird photo booth 5 may be designed to fit a first electronic device may be fit into the box 10 to capture streaming video and/or still images. Said first device may comprise many different types of devices capable of taking photographs, including but not limited to, an iPhone®, an iPod Touch®, a GoPro®, Galaxy Note®, Galaxy S4®, HTC®, LG® phone, Nokia® phone, or any other mobile device or computer that is capable of communication over the Internet via Wi-Fi, Bluetooth, cellular network, eithernet, or any wireless air or wired air interface.

With reference to FIG. 3, an exemplary second electronic device 30 that is capable of accessing the internet to view captured video and images from the bird photo booth 5 is shown. The user may then watch a live stream, record a live stream, or take still snapshots using the second electronic device 30. Thus, the bird photo booth 5 lets a user remotely watch, photograph, video record, and even talk to birds in real time and instantly share video and photo captures to social networks.

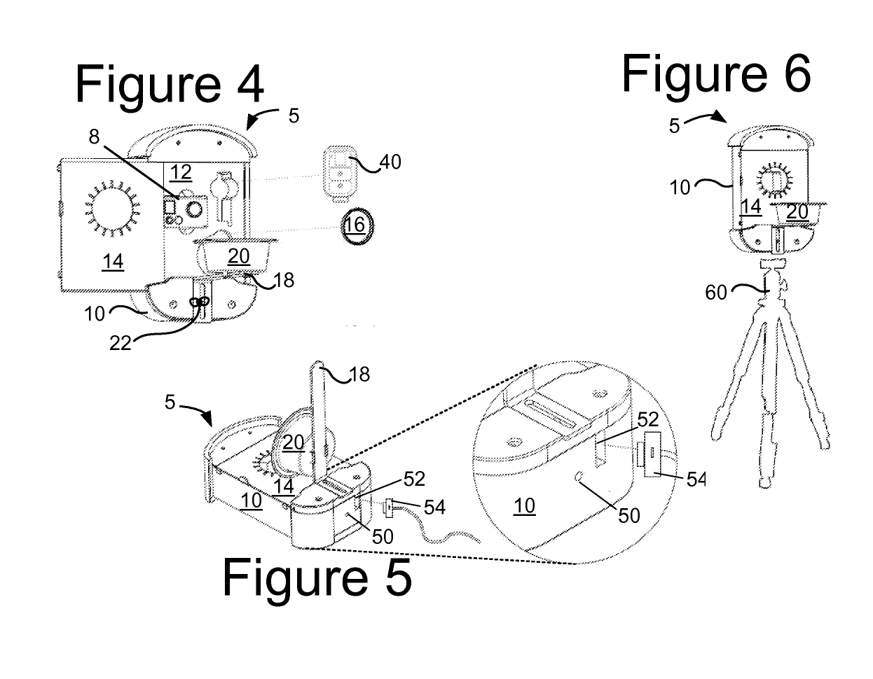

With reference to FIG. 4, the bird photo booth 5 according to the embodiment of FIG. 1 is shown, with the door 14 in the open position. An insert 12 is fitted into interior of the box with a shaped cutout to fit the first electronic device 8. The insert 12 may be fitted such that it is snug inside the box 10, and secured when the door 14 is closed, but removable so as to fit different phone inserts 12 that have cutouts for different types and shapes of electronic devices 8. Other cutouts within the insert 12 may be provided to store other equipment, such as extra lenses 16 or filters, and wifi data hub devices 40 that may be needed to connect certain types of first electronic devices 8 to the internet for streaming video.

With reference to FIG. 5, a bottom left perspective view of further detail of the box 10 of the bird photo booth 5 of the embodiment of FIG. 1 is shown. A threaded camera stand mounting hole 50 may be provided at the bottom of the box 10 to allow mounting on a camera stand, or the like, as an alternative to using the keyhole slots 27 to mount the bird photo booth 5 on a wall. An opening 52 on the bottom of the box 10 may further allow for a power and data cord 54 to be inserted to connect with the first electronic device 8 if needed. For example, a power and data cord 54 may provide prolonged continuous use of the first electronic device 8 instead of relying on battery life. Further, the cord 54 may allow for use of a non-wireless enabled device 8 to be used wherein internet data may be transmitted over the cord 54. For example, the cord 54 may be connected to an internet router. With reference to FIG. 6, a diagram illustrates the alternative fitting of the bird photo boot 5 on a camera stand 60.

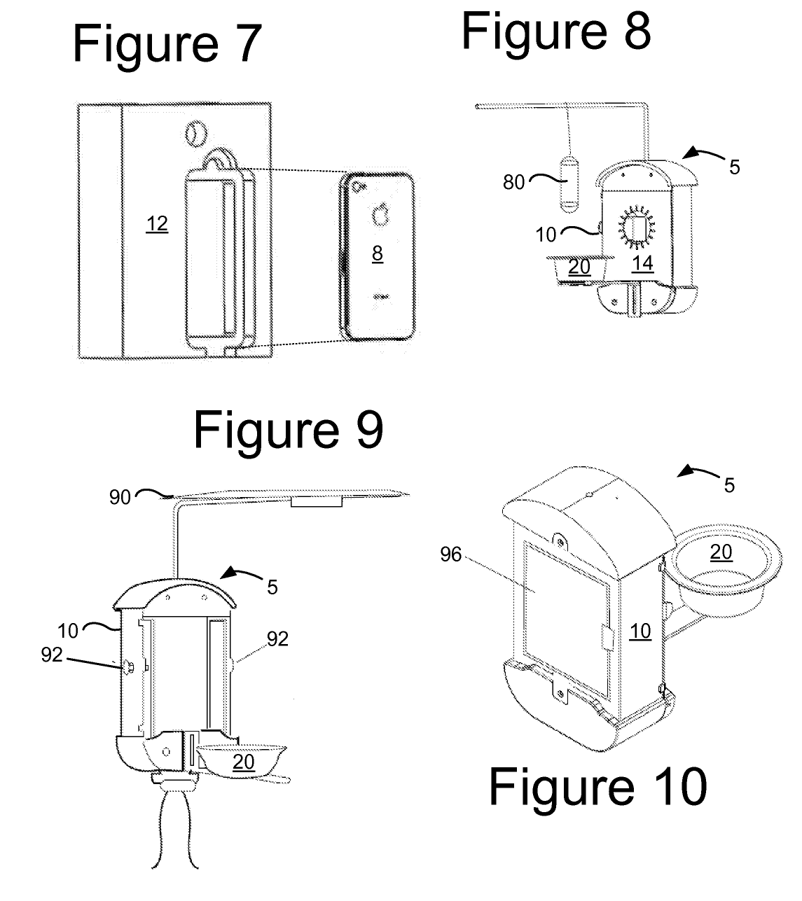

With reference to FIG. 7, a diagram illustrates an insert 12 having a differently shaped cutout for the first device 8 as that shown in FIG. 4. In one embodiment, the inserts 12 may be made of foam or other easily shaped or cut material that expands or grips the first device 8 when compressed inside the box 10. Other materials, such as Styrofoam, rubber, and the like, may be used to manufacture the insert 12.

Those of skill in the art would recognize that several available software products may be used to enable the first device 8 to transmit streaming video to the internet, and to allow viewing and control of the first device 8 using the second device 30. For example, the AirBeam application available from Appologics UG (haftungsbeschrankt), Graf-Tattenbach-Weg 4a, 82547 Eurasburg, Germany, turns the user's camera equipped electronic devices into a flexible remote monitoring system. It streams live video and audio from the cameras and microphones of any number of iPhones®, iPods® or iPads®. The user can watch the stream on any other electronic device 30 or a Web browser—even on multiple screens simultaneously. There is no need to manually configure addresses to connect devices using AirBeam software. AirBeam software automatically discovers each camera on the user's network and the user can instantly watch it. For a wifi router supporting UPNP or Apple's NAT-PMP, AirBeam even can configure port mappings automatically for remote Internet access. Thus, using the AirBeam software, the first device 8 can be automatically configured such that the user may view and record the video captured by the first device 8 using the second device 30. Further, using the AirBeam software, the user may interact with the first device 8 using the second device 30, to control the first device 8 and interact with the bird 2.

The bird feeder and remote control camera combination comprising an adjustable height and distance bird-feeding dish 20 allows for photographing birds at unprecedented close proximity. The adjustable bird food dish 20 can be moved up or down to make sure that the bird food dish 20 is cropped out of frame in the photo. The bird food dish 20 and platform slid centered in the frame and the dish's close proximity to the lens 16 forces the birds 2 to land centered and facing toward the lens 16 as they eat.

The interchangeable macro lens 16 allows for any mobile device 8 to be placed inside it. The lenses 16 may be mounted and detached from the sliding or hinged door 14 on the front side of the bird box 10. Multiple Lenses 16 can be fitted to the front door 14 of the bird box 16 in a number of ways, including magnetically or by manually threading it onto the threaded hinged or sliding door 14. The lenses 16 or field of view could be changed manually or remotely from the mobile application. The lenses 16 or field of view could also auto adjust according to what is seen in frame.

The ability to use a DSLR lens provides an improvement over conventional macro lenses designed to fit over smart phones. Conventional macro lenses designed to fit over smartphones require the user to get very close to the subject that they want to photograph. Less than an inch away from the subject is the norm. This focusing limitation of conventional macro lenses is undesirable, because the proximity of the phone to the subject can cast a shadow over the subject resulting in bad photos. It also requires the subject to almost touch the lens, which will scare them away. Instead, the bird photo booth 10 allows for attachment of DSLR lenses with a magnification 10× or more. Such DSLR lenses are available from Vivitar of Edison, N.J.

With reference to FIG. 8, an alternative bird feeder 80 is shown connected to the rod 24 to illustrate that other bird specific feeders may be alternatively used.

With reference to FIG. 9, a bird photo booth 5 with a solar panel 90 attached is shown. The solar panel may supply power to the first electronic device 8 as an alternative to using plugin or battery power. Further, the embodiment of FIG. 9 illustrates an alternative universal mounting and clamping system built inside the birdbox 10, which is designed to easily fit any mobile device 8 inside. The clamping mechanism could be magnetic. Users may place a magnet on to their mobile device's case and then it magnetically mounts to the inside back wall of the bird box 10. The inside back wall inside the bird box 10 may be spring loaded. The user magnetically mounts the mobile device of choice to the spring-loaded magnetic back wall. Once the device is secured to the back wall inside the bird box, it may automatically spring forward to the correct position behind the attachment lenses. Adjustment screws 92 for the clamping system may be provided.

In one embodiment, the bird box 10 may also contain a built in Wi-Fi or Bluetooth camera that has speakers to allow for two way audio and video. The speakers and camera could be powered by the solar panel 90 or external and internal power source.

In one embodiment, the bird box may have ¼ 20 threaded inserts on all sides to allow for mounting to the tripod 60 in multiple orientations. The ¼ 20 threaded inserts also allow other accessories to be screwed externally into the outside of the bird box, such as additional feeders, light bouncers to reflect light on to the birds eating for superior photos.

The bird box 10 may also have a reservoir inside a portion of the bird box that houses bird food. This reservoir is designed to hold large amounts of birdseed and is protected from the elements. The bird seed-dispensing reservoir would funnel out the bird seed into the adjustable bird food dish. The reservoir could also be mounted externally of the bird box and automatically dispense bird seed only when a bird lands. It does this by weight or when the camera detects motion.

With reference to FIG. 10, another embodiment of the bird box 10 may contain a rear window 96 on the reverse side that acts as a viewfinder so that users can easily see and compose the shot when setting up the feeder 20 in a new location. The clear rear window 96 on the reverse side of the façade of the bird box 10 can also be opened and expanded to fit larger devices through the backside of the bird box 10. Then the larger devices can be positioned behind the macro lens. The rear window 96 could also include an LCD viewfinder, which would show the view and allow playback of the footage captured. Alternatively when no camera is inside of it and the lenses 16 are removed from the exterior of the bird box 10, the bird box 10 can serve as a spot for birds to nest inside of it. The rear window 96 could serve as a way to view birds nesting inside the bird box 10.

The adjustable distance bird food dish 20 can be remotely controlled through the mobile application to position a bird feeding on the bird food bowl 20 to move it up or down as well as closer or further away from the lens 16 to ensure birds 2 of all sizes are captured in frame.

The bird food dish 20 can also be remotely controlled to open or close a lid to stop squirrels or unwanted animals from eating the food in the dish and also protect the food from spoiling during adverse weather. The control of the bird food lid can also be determined by weight rather than by remote control. A heavier animal will trigger the lid to mechanically close and a lighter animal will trigger the lid to open. In another embodiment, the lid is always open and only closed when a heavier animal triggers it to close, via weight. The bird food dish lid can also be designed to attract different birds. For example, a red lid may attract humming birds. The bird food dish could also be opened or closed according to light wherein a light sensor would open it when it is well lit and close when it is dark.

Another embodiment, may allow remote control of the amount and time when bird food is dispensed into the bird food dish, which can be set up automatically or in real time through the mobile application. Also, the user may be able to rotate a bird on the bird food dish 360 degrees to capture all perspectives. This will allow use of data captured to stich a real 3d model of wild birds.

Motion detection capabilities may be added wherein the built in camera or mobile device inside the bird box is automatically triggered by the weight of the bird landing on the adjustable bird food dish. Motion detection may also operate such that the mobile device's built in camera detects movement, vibration, or sound.

In another embodiment, the mobile device or camera entails a near field communication tag that would be placed on the animal. The animal (dog or cat with tagged collar or tagged bird) would trigger the camera inside the birdbox to take a photo when it approaches at close proximity.

In one embodiment, bird photo booth 5 is configured to obtain portraits of birds perched on the feeder 20. Many of the design elements described in the various embodiments herein insure that the bird's face is in focus, and that potentially distracting background detail is smoothly blurred. For example, the feeder 20 may be positioned on the perching platform 18 or rod 24 approximately five inches from the smart phone or other capture device's 8 lens (e.g. GoPro®). The macro lens 16 positioned in front of the aperture may aid in capturing sharply detailed images of feeding birds 2, and further aid in rendering backgrounds out of focus in a visually pleasing way.

A smart phone placed without a macro lens mounted on the bird photo booth aperture may be unable to focus on the bird rather than on the background. As described above, macro lenses available for direct mounting on smart phones may result in sharp focus of objects in a narrow range of about 1 inch from the smart phones lens. Such add on lenses to smart phones do not achieve focus on birds five inches from the aperture of the bird photo both 5 described herein. Telephoto lenses available for direct mounting on smart phones achieve focus at a minimum distance of eighten inches. Macro and telephoto lenses that mount directly on smart phones therefore do not achieve critical focus at approximately five inches from the bird photo booth aperture.

The macro lens 16 mounted on the aperture in the bird photo booth front cover 14 becomes a portrait lens, enabling sharply detailed image capture of birds feeding, without distracting background elements.

It should be understood, of course, that the foregoing relates to exemplary embodiments of the invention and that modifications may be made without departing from the spirit and scope of the invention as set forth in the following claims.

1. A video capture apparatus, comprising:
a box;
an insert configured to fit inside the box and to receive an electronic device having a camera;
a front cover of the box configured such that the insert positions the camera to view through a hole in the front cover;
a lens mount configured to receive a lens over the hole; and
a feeder capable of being positioned such that the camera is pointed through the lens to an animal using the feeder.

2. The apparatus of claim 1, further comprising an application that is executable on the electronic device to transmit captured video data to a network for display of said captured video data to one or more network users.

3. The apparatus of claim 2, wherein the insert is interchangeable to allow for two or more types of electronic devices so as to allow for positioning, via the interchangeable insert, of camera of the two or more types of electronic devices behind the lens.

4. The apparatus of claim 3, wherein the interchangeable insert provides for the insert to include two or more interchangeable cutouts in the insert to accommodate the two or more types of electronic devices.

5. The apparatus of claim 1, further comprising an adjustable food dish to attract animals such that said food dish may be positioned for ideal capture of the animal by a field of view of the camera.

6. The apparatus of claim 5, wherein the height of the food dish is adjustable.

7. The apparatus of claim 5, wherein the distance of food dish from the lens is adjustable.

8. The apparatus of claim 1, further comprising a removable rod from which the feeder may be hung to provide for two or more different types of feeders to attract different types of animals.

9. The apparatus of claim 1, wherein the animal comprises a bird.

10. The apparatus of claim 1, further comprising a keyhole bracket configured to mount the box on a vertical surface.

11. The apparatus of claim 1, further comprising a threaded hole capable of receiving a camera stand mounting screw for mounting the box on a camera stand.

12. The apparatus of claim 1, wherein the lens comprises a macro lens.

13. The apparatus of claim 1, wherein the lens comprises a DSLR lens.

14. A video capture apparatus, comprising:
a box;
an insert configured to fit inside the box and to receive a first electronic device having a camera;
a front cover of the box configured such that the insert positions the camera to view through a hole in the front cover;
a lens mount configured to receive a lens over the hole;
a feeder capable of being positioned such that the camera is pointed through the lens to an animal using the feeder; and
a network connection configured to provide video signals captured by the camera of the first electronic device to a location on a network that is accessible for viewing by a second electronic device.

15. The apparatus of claim 14, further comprising an application that is executable on the first electronic device to transmit the video signals to the network location.

16. The apparatus of claim 15, wherein the insert is interchangeable to allow for two or more types of first electronic devices so as to allow for positioning, via the interchangeable insert, of camera of the two or more types of first electronic devices behind the lens.

17. The apparatus of claim 16, wherein the interchangeable insert provides for the insert to include two or more interchangeable cutouts in the insert to accommodate the two or more types of first electronic devices.

18. The apparatus of claim 14, further comprising an adjustable food dish to attract animals such that said food dish may be positioned for ideal capture of the animal by a field of view of the camera.

19. The apparatus of claim 14, further comprising a removable rod from which the feeder may be hung to provide for two or more different types of feeders to attract different types of animals.

20. The apparatus of claim 14, wherein the lens comprises a macro lens.

21. The apparatus of claim 14, wherein the lens comprises a DSLR lens.

22. A video capture method, comprising:
fitting an insert inside a box to receive a first electronic device having a camera;
closing a front cover of the box such that the insert positions the camera to view through a hole in the front cover;
receiving a lens over the hole;
positioning a feeder such that the camera is pointed through the lens to an animal using the feeder; and
providing signals captured by the camera to a location that is accessible on a network by a second electronic device capable of displaying the signals captured by the camera.
